(19) United States
(12) Patent Application Publication
(10) Pub. No.: US 2015/0103290 A1
(43) Pub. Date: Apr. 16, 2015

(54) Visual Display Apparatus

(71) Applicant: Design Bridge Limited, London (GB)

(72) Inventor: Edward Arthur Charles MITCHELL, London (GB)

(73) Assignee: Design Bridge Limited, London (GB)

(21) Appl. No.: 14/193,119

(22) Filed: Feb. 28, 2014

(30) Foreign Application Priority Data
Oct. 15, 2013 (GB) 13 18 324.9

(51) Int. Cl. G09G 3/34; G09G 3/36; G02F 1/1335

(52) U.S. Cl. CPC G09G 3/3406; G02F 1/133528; G09G 3/3611; G02F 2001/133531; G02F 2001/133562; G02F 2001/133567
USPC 349/61; 345/690; 345/102

(57) ABSTRACT

Visual display apparatus comprises a screen viewable from a viewing area and including an array of pixels, a lighting device operative to illuminate the pixels thereby to produce illumination directed along a path towards the viewing area, a control device operative selectively on the pixels to modulate the illumination in relation to a visual image; and a filter device operative to filter the modulated illumination thereby to reveal the visual image. The screen and the filter device are relatively so configured and arranged that in the viewing area the visual image and the modulated illumination are alternatively displayed.

### CROSS REFERENCE TO RELATED APPLICATIONS

This application claims priority from United Kingdom Patent Application No. 13 18 324.9 filed Oct. 15, 2013, the whole contents of which are incorporated herein by reference in their entirety.

### BACKGROUND OF THE INVENTION

1. Field of the Invention

This invention concerns visual display apparatus, such as a liquid crystal display (LCD), for displaying an image at a viewpoint, particularly but not necessarily exclusively for promotional or advertising purposes.

2. Description of the Related Art

The construction, components and operation of an LCD display system are all well known but can be briefly described as follows. Any readily available LCD panel may be used, but it is convenient to consider the invention in relation to an active-matrix panel of the transmissive kind, which is to say that light from a light source (commonly called a backlight) behind the panel is transmitted through the panel on an optical path towards the viewpoint. The panel typically comprises a layer of twisted nematic liquid crystal material sandwiched between a pair of glass plates etched on their mutually facing surfaces to force a generally helical or “twisted” alignment for the liquid crystals. Against the panel is a pixel array in which each pixel comprises three sub-pixels respectively red, green and blue (RGB). When an electric field (controlled by a respective transistor for each sub-pixel in the array) is applied to the crystals in the panel they attempt to align with the field and thereby untwist to an extent determined by the strength of the applied field. Two linearly polarizing filters or “polarizers” are located on the optical path, one behind the panel and the other in front of it. The polarizers are mutually crossed—that is, the rear polarizer is polarized one way (say horizontally) and the fore polarizer is polarized another way (say vertically).

In operation, light from the backlight is transmitted forwards and is horizontally polarized by the rear polarizer. This horizontally polarized light passes through the RGB sub-pixels and is thus colored. Consider first a liquid crystal to which no electric field is applied. This crystal is in a twisted state, and so is circularly birefringent. The colored and horizontally polarized light incident upon it is therefore turned through 90 degrees, ie into vertical polarization. The fore polarizer is vertically polarized, and accordingly it allows the light to pass through. Now consider a liquid crystal to which an electric field is applied. As before, the rear polarizer gives horizontal polarization to the light transmitted by the backlight, but owing to the application of the electric field, the crystal loses its circular birefringence, thereby allowing (horizontally polarized) light to pass through it unchanged, and so the vertical polarization of the fore filter blocks it.

The transistors controlling the current to the individual crystals respond to signals representing the image to be displayed. Accordingly the crystals act like shutters by being twisted/untwisted to a degree related to the image. Then, according to the degree of twist/untwist, the fore filter either blocks or passes the light passing through the crystals and thereby forms the image to be displayed at the viewpoint. Until it is acted upon by the fore polarizer, the light passing through the crystals contains all the information content of the image, but the image is not viewable: in fact, until the light passing through the crystals also passes through the fore polarizer, all that can be seen is plain illumination—typically white light (as a combination of red, green and blue) possibly gray or tinted. In other words, the light is modified to include the information content of the image and then filtered to reveal the image.

The image may be a still or a moving image or, particularly for the purposes of advertising and promotion, a repeating sequence of either; and conventionally the display continues as long as the apparatus is switched on.

It is an object of this invention to provide means for controlling the display.

### BRIEF SUMMARY OF THE INVENTION

Thus according to a first aspect of the invention there is provided visual display apparatus comprising: a screen viewable from a viewing area and including an array of pixels; a lighting device operative to illuminate the pixels thereby to produce illumination directed along a path towards the viewing area; a control device operative selectively on the pixels to modulate said illumination in relation to a visual image; and a filter device operative to filter the modulated illumination thereby to reveal the visual image; wherein the screen and the filter device are relatively so configured and arranged that in the viewing area the visual image and the modulated illumination are alternatively displayed. So that the visual image is colored (ie polychromatic), each said pixel preferably comprises a set of RGB sub-pixels.

Preferably the screen is included in an LCD panel and the filter device comprises a first polarizer and a second polarizer, which polarizers are mutually crossed. In this arrangement the first polarizer may located between the lighting device and the LCD panel (as a rear polarizer) and the second polarizer located between the LCD panel and the viewing area (as a fore polarizer).

Those skilled in the art will know that a conventional LCD display has the fore and rear polarizers adhered to it, so neither is movable. In one form of the present invention, by contrast, one of the polarizers is movable. Thus, in this form, a movable one of said first and second polarizers is movable between an operative position on said path whereby the visual image is displayed in the viewing area and a null position off said path whereby the modulated illumination is displayed in the viewing area.

The invention has particular uses in advertising and promotion. For instance, the LCD form of the invention may be embodied in a package containing a product being promoted and the fore polarizer—which may be secured to a transparent block of form similar to the promoted item—selectively positioned manually to show or not to show an image relating to the product.

In a second aspect the invention provides a method of producing a visual display in a viewing area, which method comprises providing a screen viewable from the viewing area and including an array of pixels, illuminating the pixels to produce illumination directed along a path towards the viewing area, optically modulating the illumination in relation to a visual image and optically filtering the modulated illumination to reveal the visual image, wherein the modulation of the illumination and the filtering of the illumination are mutually separated so that the modulated illumination and the visual image are alternatively displayed in the viewing area.

In this method, the modified illumination may be filtered by mutually crossed polarizers spaced apart to enable the modulated (but unfiltered) illumination to be seen as well as the (filtered) visual image. Otherwise one of the polarizers may be movable relative to the other between one position in which the modulated (but unfiltered) illumination is seen from the viewing area and another position in which the (filtered) image is seen from the viewing area.

### BRIEF DESCRIPTION OF THE DRAWINGS

Other features of the invention will be apparent from the following description, which is made by way of example only and with reference to the accompanying schematic drawings in which:

FIG. 1 illustrates the structure, components and operation of a visual display system according to the invention;

FIG. 2 illustrates in plan view a package for promoting a product, which package embodies a visual display system according to the invention, with a movable polarizer mounted on a transparent block shown in its operative position;

FIG. 3 is a view corresponding to FIG. 2 but showing the movable polarizer moved to a null position;

FIG. 4 is an isometric view of the system of FIGS. 2 and 3 illustrating the similarity in form between the product being promoted and the transparent block carrying the movable polarizer;

FIG. 5 shows an embodiment of the invention having a fore polarizer which is fixed and in the form of a free-standing emblem;

FIG. 6 shows an embodiment of the invention having a plurality of emblematic fore polarizers fixed to a window;

FIG. 7 shows an embodiment of the invention having an emblematic fore polarizer fixed in a box;

FIG. 8 shows an embodiment of the invention having a fore polarizer comprising a plurality of strips extending across and above a table;

FIG. 9 shows an embodiment of the invention having fore polarizers fixed to sales plinths;

FIG. 10 shows an embodiment of the invention in the form of a wall;

FIG. 11 shows an embodiment of the invention having manually movable fore polarizers;

FIG. 12 shows an embodiment of the invention having fore polarizers included in drinks containers;

FIG. 13 shows an embodiment of the invention for disclosing a code to enable access to a restricted area;

FIG. 14 shows an embodiment of the invention having a plurality of fore polarizers suspended in the form of a mobile;

FIG. 15 shows an embodiment of the invention having fore polarizers in the form of loosely hung ribbons; and

FIG. 16 shows in side elevation an embodiment of the invention configured and arranged with child protection in mind.

### DETAILED DESCRIPTION OF EXAMPLE EMBODIMENTS

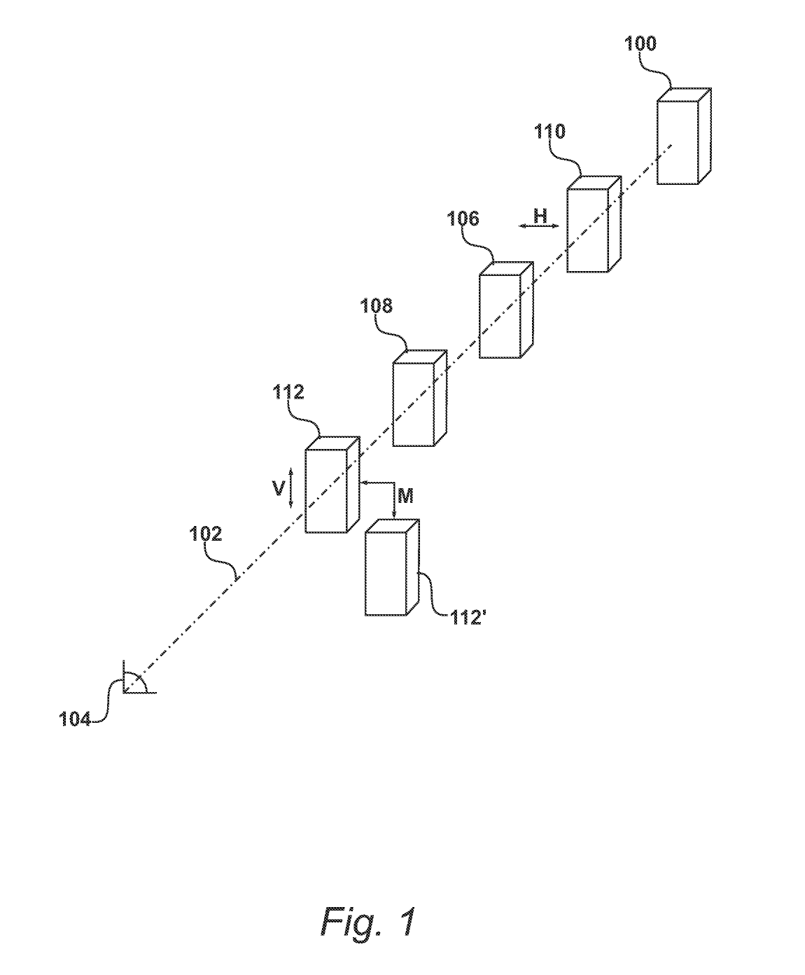

### FIG. 1

Referring first to FIG. 1, display apparatus according to the invention is shown to comprise a backlight 100 configured and arranged to transmit light along a path 102 towards a viewpoint 104. The backlight may be of any appropriate kind, with fluorescent or other light sources, and those skilled in the art will appreciate that diffusers and the like may be provided to ensure that the light is even.

The path 102 extends through a pixel array 106 comprising multiple rows and columns of RGB sub-pixels and then through an active-matrix LCD panel 108. Although not detailed in FIG. 1, the LCD panel 108 comprises liquid crystals sandwiched between a pair of glass plates etched on their mutually facing surfaces to define a generally helical or “twisted” alignment for the liquid crystals and, arranged in rows and columns corresponding to those of the pixel array, transistors whereby electric current may be delivered to the liquid crystals. The application of this current to a particular crystal causes the crystal to untwist. Thus with no current applied to a crystal, the light passes straight through the LCD panel 108, whereas with the current applied, the light is rotated through 90 degrees.

On the path 102 and between the backlight 100 and the pixel array 106 is a rear polarizer 110. This gives horizontal polarization to the light transmitted from the backlight 100, as indicated by the arrows H. Thus light emerging from the LCD panel 108 will remain horizontally polarized if it passes through an untwisted crystal (ie one to which current is applied) but will be vertically polarized if it passes through a twisted crystal (ie one to which no current is applied).

Forward of the LCD panel 108, ie towards the viewpoint 104, and on the path 102 is a fore polarizer 112. This is vertically polarized, as indicated by the arrows V. Accordingly the fore polarizer 112 will pass the vertically polarized light from the twisted crystals and block the horizontally polarized light from the untwisted crystals. In this way, as is well known, by passing controlled and directed coloured light and blocking unwanted light an image can be constructed to be seen at the viewpoint 104.

Thus far the display apparatus of FIG. 1 is conventional. However the present invention differs from what is previously known in that the fore polarizer 102 is movable, as indicated by the arrows M, between its operative position on the path 102 and a null position 112′. It will be understood that in this null position 112′ —which is arbitrary, as long as it is off the path 102—the fore polarizer 112 does not block the unwanted light and accordingly only a blank or white screen can be seen at the viewpoint 104.

This screen comprises the forward face of the LCD panel 108. The light from the backlight 100 is polarized by the rear polarizer 110 but it all passes through the LCD panel 108 as RGB sub-pixels multiplexed into closely adjacent red, blue and green components that together appear white in the absence of the fore polarizer 112. When the fore polarizer 112 is located on the path 102 it demultiplexes the RGB sub-pixels by controlledly blocking certain of the sub-pixels light thereby to produce an image on the screen.

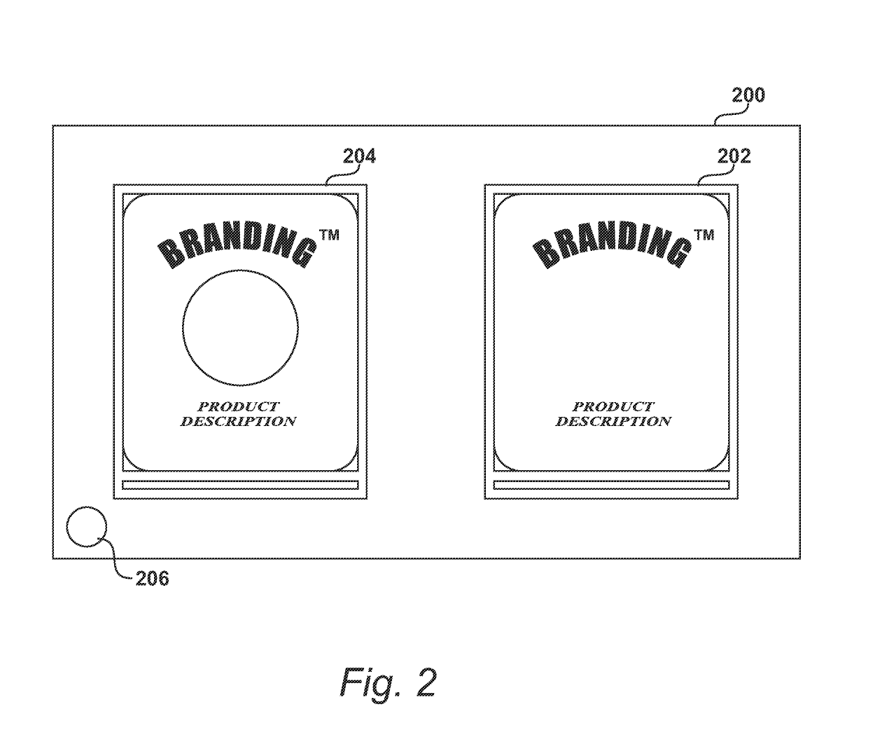

A way in which this difference between a displayed image and a blank screen can be exploited for advertising and promotional purposes will now be described with reference to FIGS. 2 to 4.

### FIG. 2

Referring to FIG. 2, this shows in plan view a promotional package 200 containing, within a recess in the package 200, a product 202 being promoted. Purely for purposes of illustration, the product 202 being promoted is shown in the form of a branded box that can contain an item or items of value but it should be understood that the product 202 may be different.

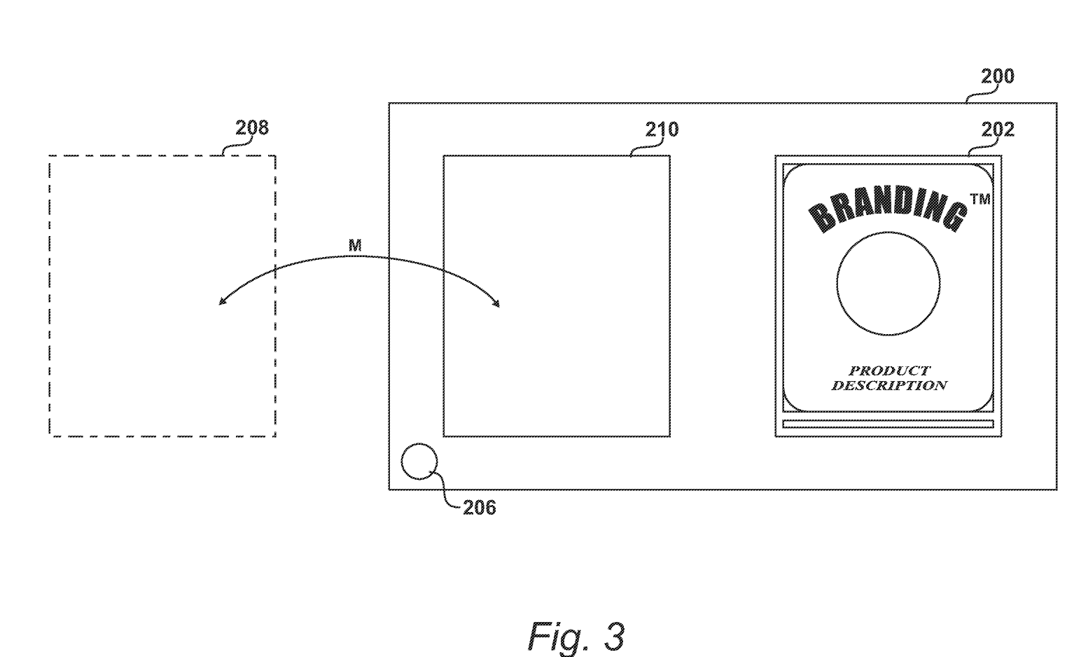

### FIG. 3

Adjacent the product 202 is an image 204 of the same product. This image 204 is produced by display apparatus of the kind described above with reference to FIG. 1, contained in the package 200 along with a power supply and control circuitry etc operable by means of a switch 206. The display apparatus has a fore polarizer that, as shown by the arrows M in FIG. 3, can be moved between its operative position forming the image 204 to a null position 208. The fore polarizer is inoperative in this null position 208, and thus the image 204 of FIG. 2 is replaced by the blank screen 210 of FIG. 3.

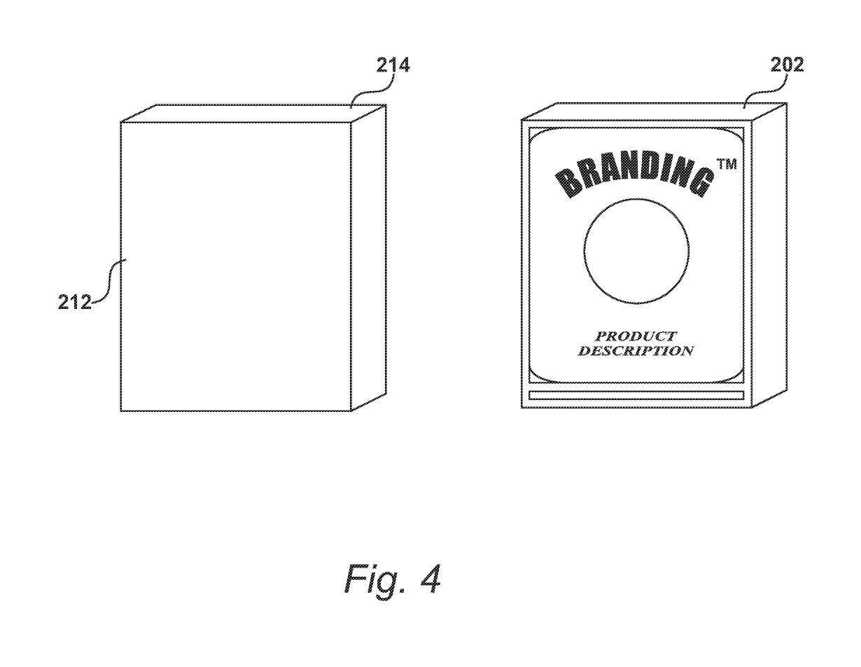

### FIG. 4

As shown in FIG. 4, the fore polarizer 212 is carried on a transparent acrylic block 214 of form similar to that of the product 202. This feature, and the fact that the image 204 disappears when the block 214 is lifted out of the package 200 (and reappears when the block is replaced) contributes to the promotion of the product 204 by adding interest and memorability.

The fore polarizer 212 is carried on a face of the block 214 that in operation is adjacent the LCD panel of the display apparatus. The package 200 is formed with a recess for the block 214, coterminous with the screen 210, whereby the polarizer 212 is properly aligned in its operative position.

It should be understood that the apparatus may display something different from an image of the product 202. For instance it may display an advertising and/or informational film about the product 202, or other images intended to be memorable.

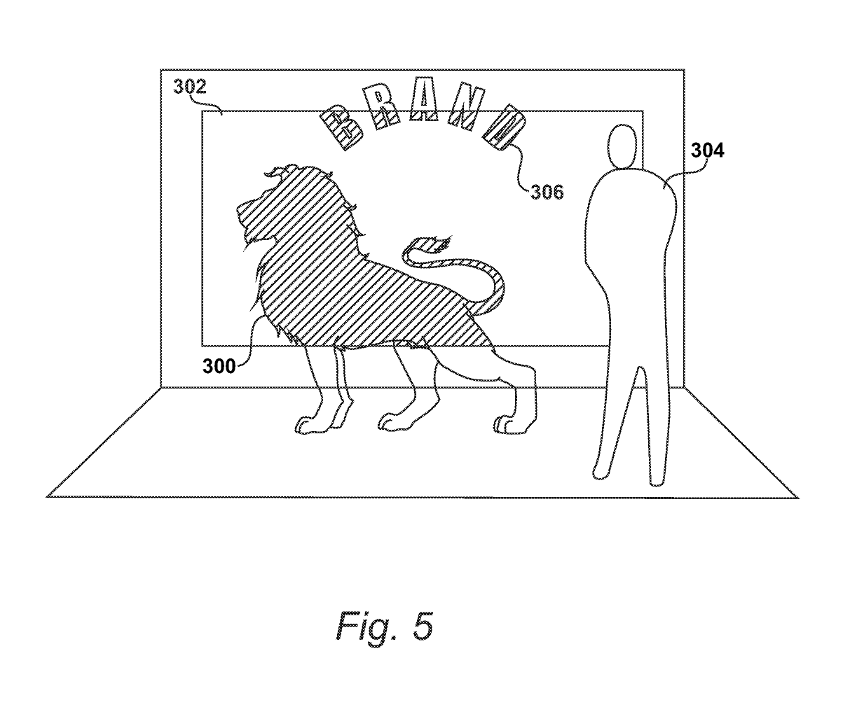

Other embodiments of the invention will now be described with reference to FIGS. 5 to 16.

### FIG. 5

FIG. 5 shows an arrangement in which the fore polarizer 300 is in the form of an emblem (such as a design or other special form of a trade mark) having a distinctive silhouette—in this case that of a lion, although it will be understood that the precise form is not significant. This distinctively-shaped fore polarizer 300 stands in front of a screen 302 which, as will be understood from the foregoing description with reference to FIGS. 1 to 4, comprises the front face of an LCD panel backed by a light box and a rear polarizer. The fore polarizer 300 stands between the screen 302 and a viewing area wherein the screen 302 may be viewed (a viewer is indicated at 304) both through the fore polarizer 300 and past the fore polarizer 300. Through the fore polarizer 300, an image—shown symbolically in FIG. 5—is seen by the viewer 304, and this image (which may be still or moving) can relate to a product symbolized by the emblematic form of the fore polarizer 300. At the same time, the viewer 304 can see past the fore polarizer to a plain white screen. This adds contrast and interest. And for advertising purposes the impact of the arrangement is emphasised by hanging in front of the screen 302 a banner 306 in the form of a brand name that also acts as a fore polarizer.

The fore polarizer of FIG. 5 (both the emblem 300 and the banner 306) is formed of transparent acrylic material. It may be used for artistic purposes, for instance in an atelier. Or it may be used for advertising purposes, for instance for travelling duty-free displays.

The configuration of FIG. 5, and in particular the relative disposition of the screen 302 and the fore polarizer 300, is such that it is not necessary to move the fore polarizer 300 to display white light and an image alternatively. Among the other embodiments of the invention now to be described, some have moving fore polarizers like that of FIGS. 1 to 4 and the others have fixed fore polarizers like that of FIG. 5.

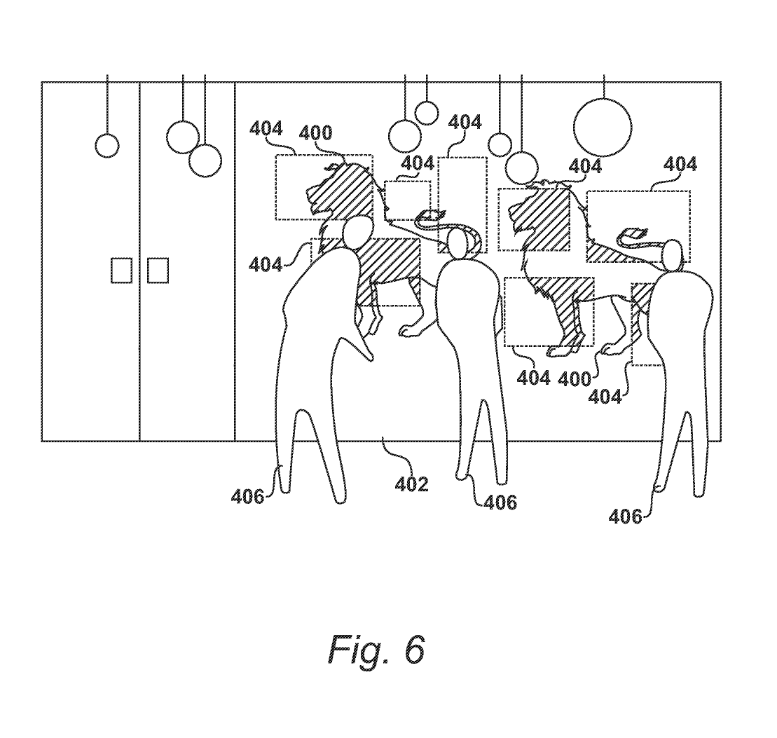

### FIG. 6

The embodiment of FIG. 6 is another arrangement with fixed fore polarizers. In this embodiment the fore polarizers 400 are attached to a window 402 of a shop or the like. Behind the window 402 is a plurality of screens 404 indicated in broken lines and each comprising the forward face of an LCD panel backed by a backlight and a rear polarizer. By aligning the fore polarizers 400 on the window 402 with the screens 404 within the shop, viewers 406 in a viewing area in front of the window 402 see visual images—shown symbolically in FIG. 6.

The arrangement shown in FIG. 6 provides a visually attractive frontage to a club entrance, premium lounge, VIP area or the like, or for corporate events. Also, by forming the fore polarizers 400 as emblems with a distinctive silhouette, the arrangement of FIG. 6 provides an impactful advertising display.

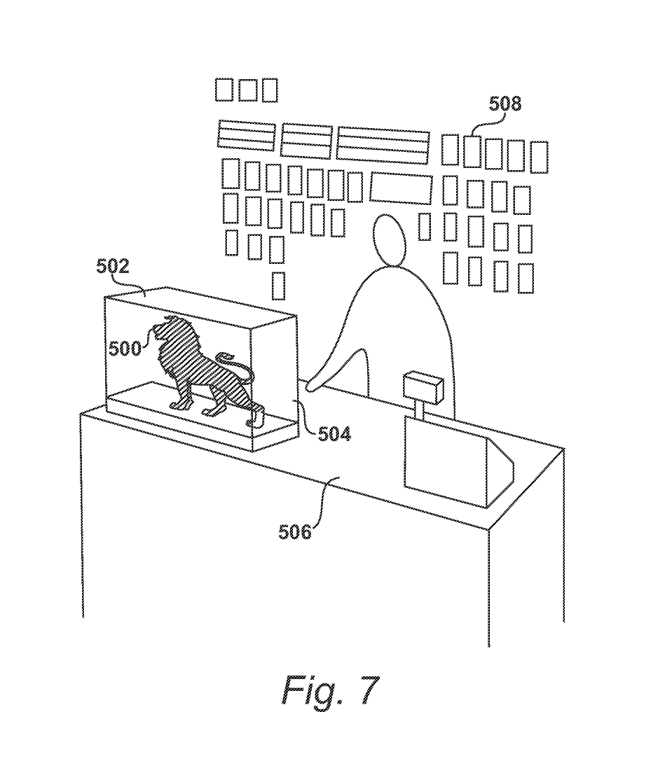

### FIG. 7

Like the embodiment of FIG. 6, the embodiment of FIG. 7 also has a fixed fore polarizer formed as an emblem with a distinctive silhouette and typically representing a trade mark. In this embodiment the fore polarizer 500 is mounted within a box 502 the front, sides and top of which are transparent but the back 504 of which comprises the forward face of an LCD panel backed by a backlight and a rear polarizer. The box 502 is set upon a sales counter 506 arranged for the sale of products 508 to which the emblem of the fore polarizer 500 relates. Persons approaching the counter 506 are attracted by the display provided by the box 502 and thereby encouraged to purchase the products 508. It should be noted that although the fore polarizer 500 is fixed within the box 502, the box as a whole is portable (the visual display system can be battery-powered) and readily relocated.

The box 502 of FIG. 7 is formed of transparent acrylic material so that persons approaching the counter 506 can look through the fore polarizer 500 and thereby see a visual image—shown symbolically in FIG. 7—such as a video clip. And whilst the embodiment of FIG. 7 has been described above as located on a sales counter, it will be understood that the visual display system contained in the box 502 can be used elsewhere, for instance on a bar counter or a reception desk, or as in-shelf disruption in duty-free areas.

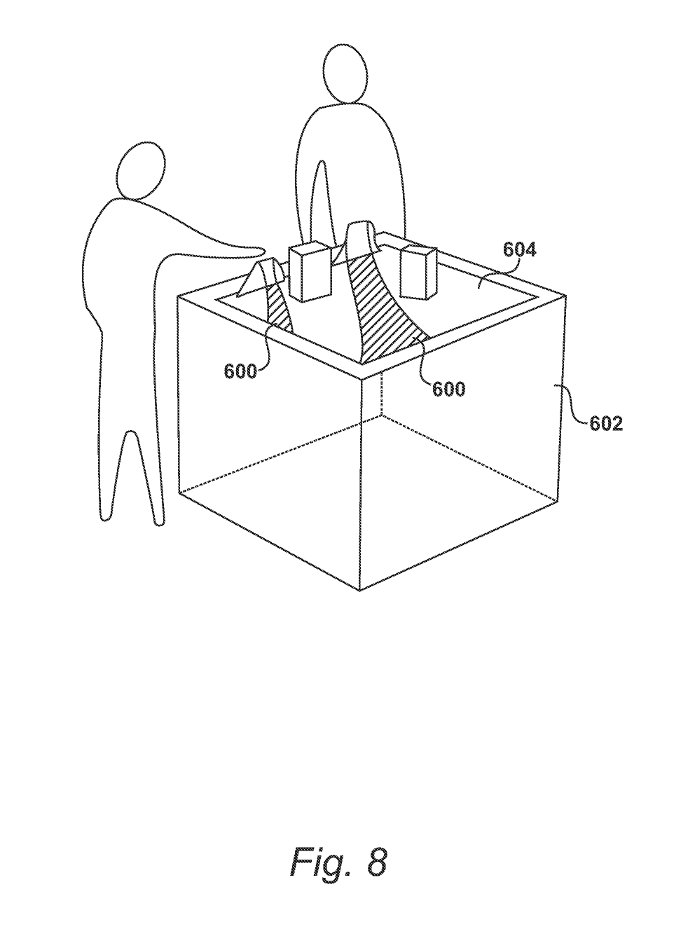

### FIG. 8

In the embodiment of FIG. 8 the fore polarizer comprises a plurality of strips 600 extending across and above a table 602 the top 604 of which comprises a screen backed by an LCD panel and a backlight configured and arranged as described above with reference to FIG. 1. In use the top 604 of the table 602 appears white except as viewed through the strips 600, when a visual image shown symbolically in FIG. 8 is seen.

The table 602 is formed of transparent acrylic material and may be used in, for instance, a smoking lounge or otherwise in hotels, restaurants or catering premises.

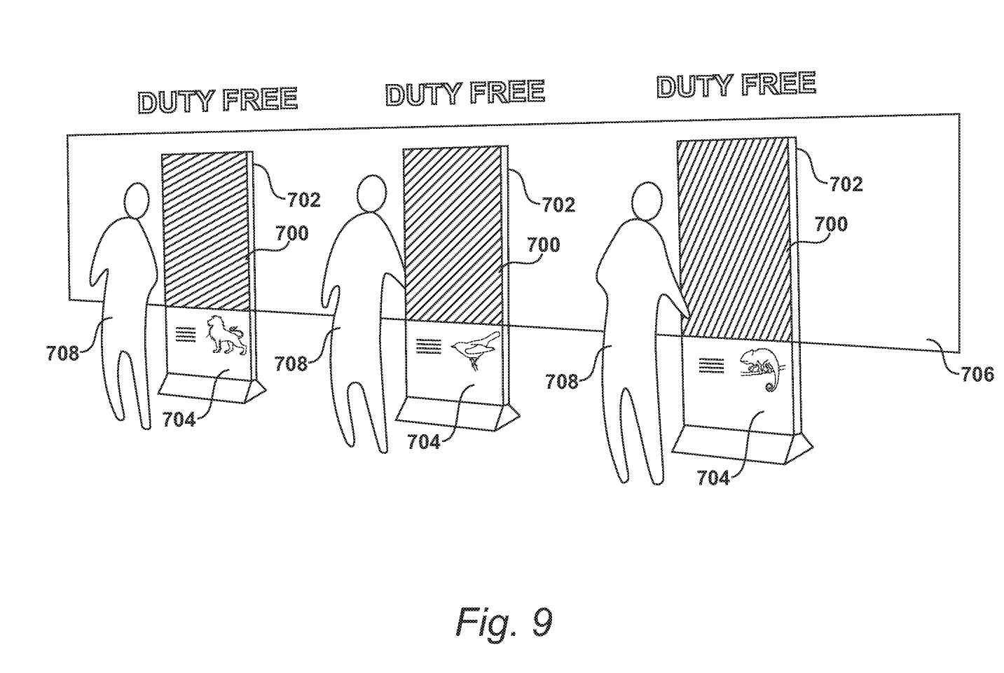

### FIG. 9

FIG. 9 shows an embodiment of the invention having a plurality of fore polarizers 700 respectively located on transparent raised portions 702 of stands 704 for products in retail premises such as a duty-free shop. The stands 704, which may carry products such as cigarettes, are in the form of plinths fixed in front of a screen 706 backed by an LCD panel and a backlight configured and arranged as described above with reference to FIG. 1. Visitors 708 to the retail premises are drawn to the plinths 704 by seeing an image—shown symbolically in FIG. 9—through the fore polarizers 700. The space between the plinths 704 and the screen 706 means that visitors 708 can view the white screen 706 past a fore polarizer 700 and also view an image through a fore polarizer 700, and this adds advertising impact.

Typically, the plinths 704 are brand-specific and thus the visual display system of FIG. 9 is arranged to deliver brand-specific visual content. Whilst the embodiment of FIG. 9 has been described above as in a duty-free shop it will be understood that this embodiment has numerous other potential uses in clubs, hotels, restaurant or catering premises or more generally for advertising and sales promotion.

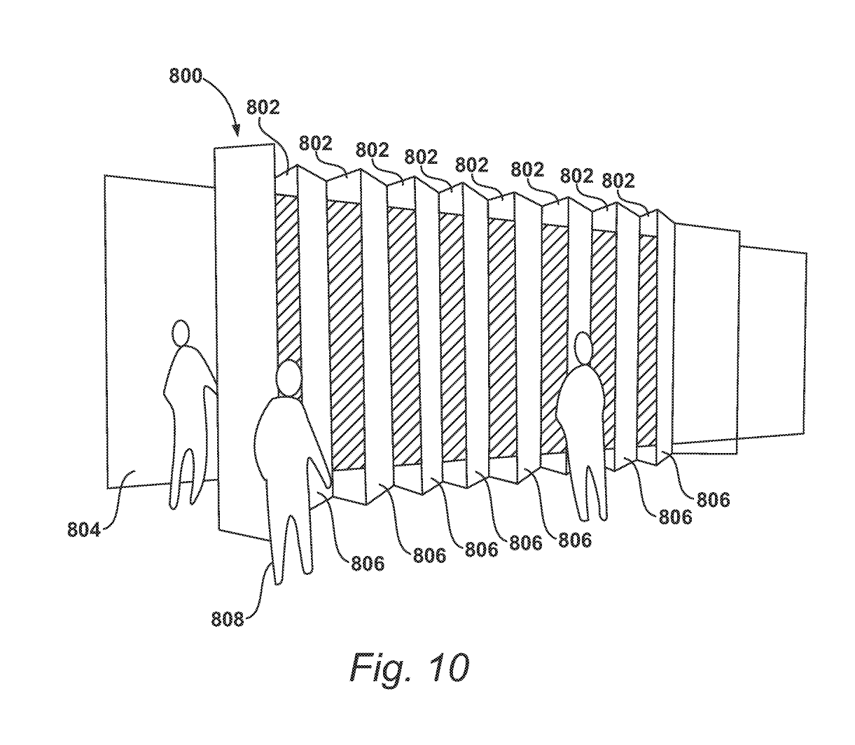

### FIG. 10

The arrangement of FIG. 10 has a wall indicated at 800 and comprising plurality of fixed fore polarizers 802 fixed in front of and spaced apart from a screen 804 backed by an LCD panel and a backlight configured and arranged as described above with reference to FIG. 1. As shown in FIG. 10 the wall 800 is of zigzag form, with the fore polarizers 802 in the form of vertical bands angled one way and intercalated with non-polarizing areas 806 orthogonal to the fore polarizers 802. The zigzag form is a convenient way of making the wall 800 freestanding. (Alternatively, the wall 800 may be provided with feet. Otherwise the fore polarizers 802 may be individually located, floor-mounted or suspended from above, with non-polarizing areas in the form of spaces between them through which viewers may pass.)

Persons 808 in a viewing area in front of the wall 800 see an image—shown symbolically in FIG. 10—displayed by way of the fore polarizers 802. The space between the wall 800 and the screen 804 means that the white screen 804 can be seen from the viewing area, past the wall 800 (or otherwise through spaces between the fore polarizers 802, if the wall 800 be so arranged.) The space between the wall 800 and the screen 804 also allows persons to pass behind the wall 800, from where they see nothing on the rear face of the wall, which creates intrigue and adds advertising impact.

In effect the arrangement of FIG. 10 provides a double-sided wall of which one side can feature permanent advertising. It may be used in duty-free shops or trade shows or in hotel, restaurant or catering premises.

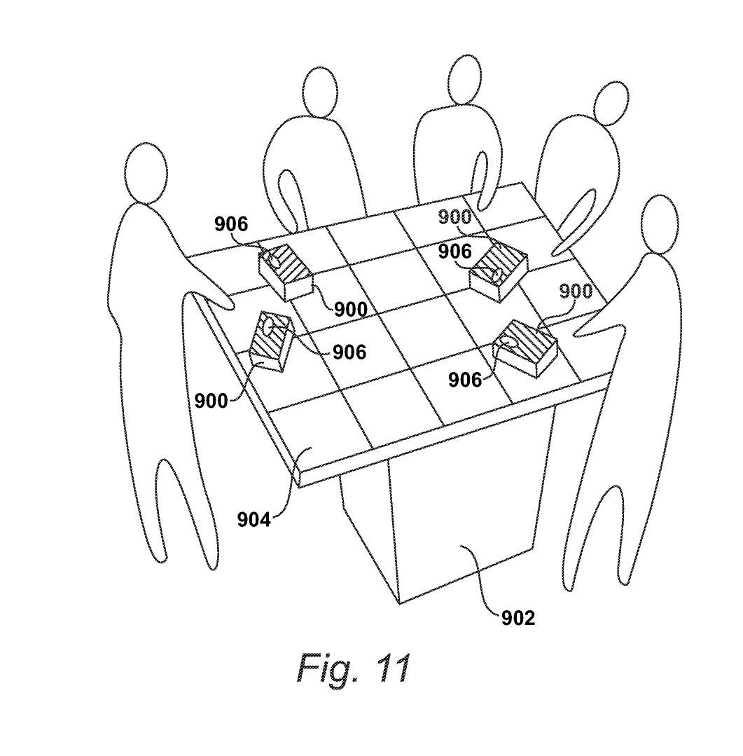

### FIG. 11

The arrangement of FIG. 11 has fore polarizers each embodied in a manually portable item 900 movable across a pedestal 902 that supports the items 900 and has on its top a screen 904 backed by an LCD panel and a backlight configured and arranged as described above with reference to FIG. 1. The screen is white, save as viewed through the fore polarizers embodied in the items 900, when a visual image—shown symbolically in FIG. 11—is displayed. Manual movement of the items 900 reveals different parts of the image, or other displays.

As can be seen in FIG. 11, the screen 904 comprises a plurality of rectilinear sectors. Each person around the pedestal 902 (or a selected subset of them) has a respective item 900 which, when placed on the screen 904, displays a visual image comprising a video clip, graphics and text. Each item 900 includes a near field communication (NFC) device 906 whereby sector-related sound in the form of speech and/or and music or other sounds synchronised with the visual image is communicated to persons around the pedestal 902. This arrangement may be used for conferences or other purposes such as trade events or road shows or in a smoking lounge or otherwise in hotel, retail or catering premises.

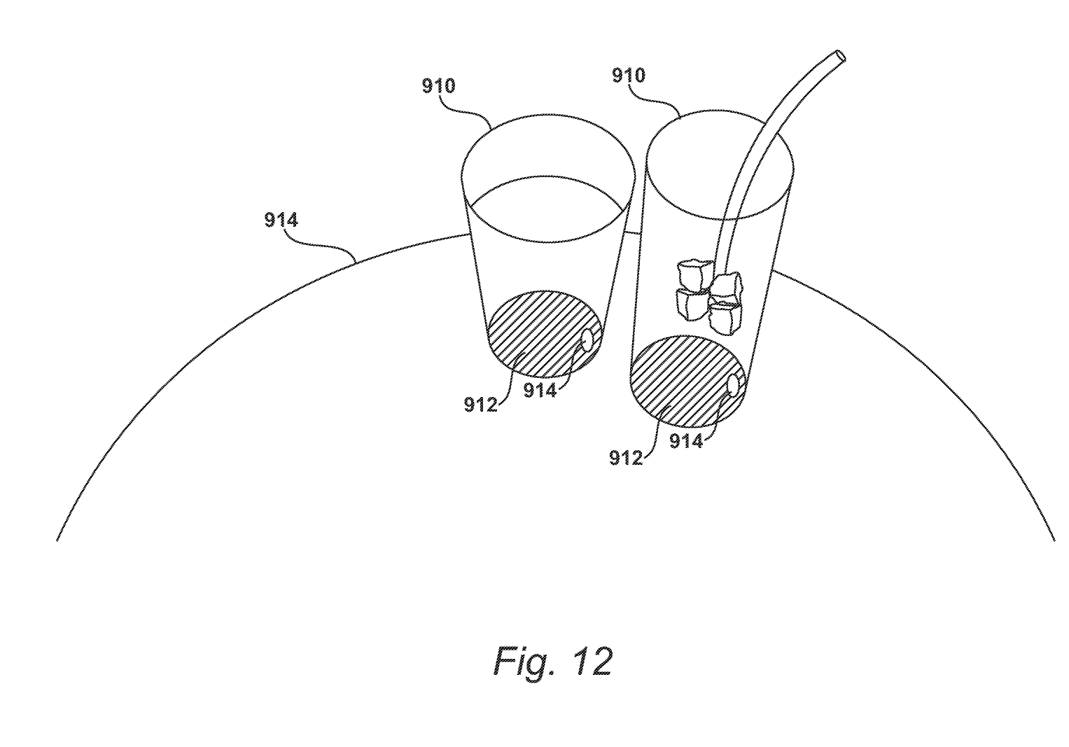

### FIG. 12

FIG. 12 illustrates a variant of the FIG. 11 embodiment of the invention, in this case with manually portable items in the form of drinking glasses or other drinks containers 910. Each drinking glass 910 has in its bottom a fore polariser 912. A tabletop or bar counter 914 comprises a screen 904 backed by an LCD panel and a backlight configured and arranged as described above with reference to FIG. 1. When a drinking glass 910 is placed on the tabletop 914 a visual image—shown symbolically in FIG. 12—can be seen through the bottom of the drinking glass 910. An NFC chip 914 is embedded within each drinking glass 910 whereby customised or targeted sound messages can be delivered to the drinker in addition to the visual image.

Thus the embodiment of FIG. 12 provides a table-mounted screen which, in association with polarizers in drinking containers, reveals otherwise hidden visual images. This arrangement can be used in a club or a smoking lounge or elsewhere in hotel, restaurant or catering establishments.

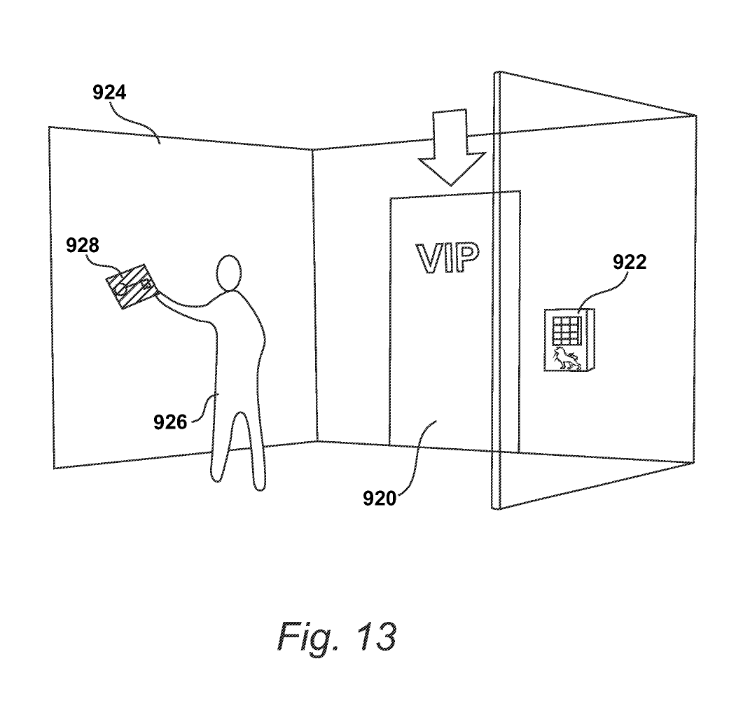

### FIG. 13

A different arrangement including a manually portable item including a fore polarizer is illustrated by FIG. 13. In this arrangement a door 920 controlled by a keypad 922 restricts access to a private function room. To one side of the door 920 is a screen 924 backed by an LCD panel and a backlight configured and arranged as described above with reference to FIG. 1. (In use the screen 924 illuminates the approach to the door 920). A person 926 invited to the private function is furnished with an invitation card 928 embodying a fore polarizer. When (and only when) the card 928 is placed against the screen 924, the fore polarizer causes a code to be displayed, which the person 926 can then key into the keypad 922 and thereby open the door 920 to gain access to the private function.

The arrangement of FIG. 13 may be used in relation to private functions in hotel, restaurant and catering establishments or may otherwise be used to control access to a club or the like.

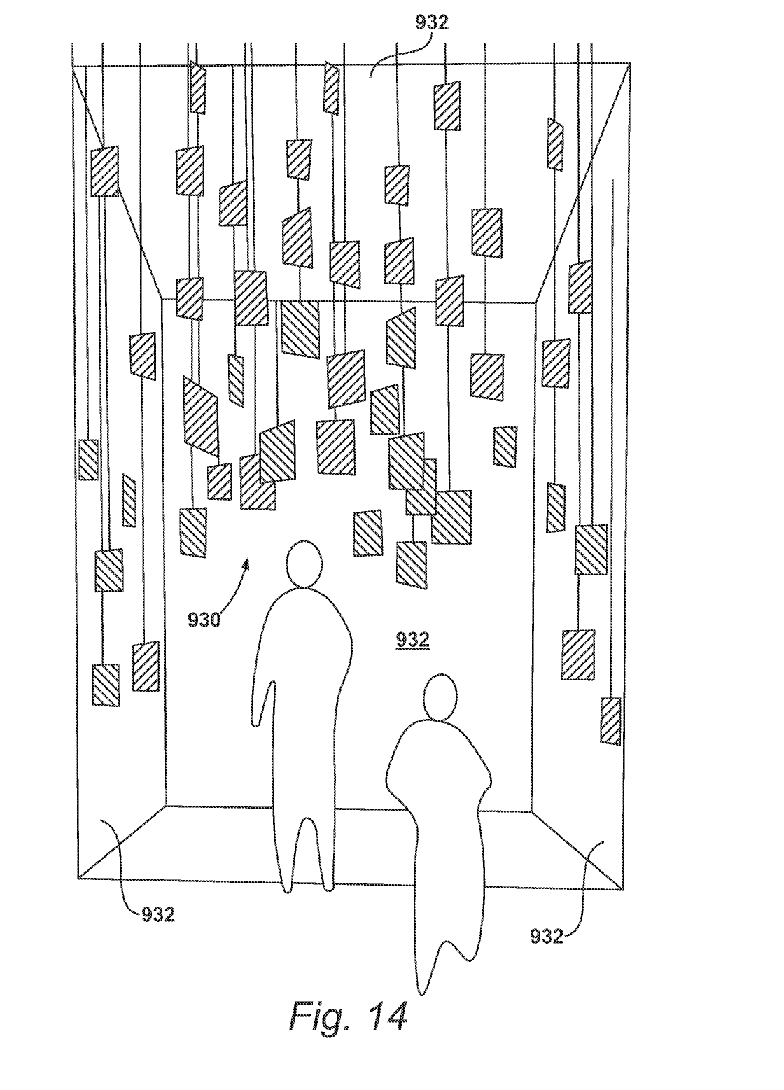

### FIG. 14

In the embodiments of the invention shown in FIGS. 2 to 4, 11, 12 and 13 the fore polarizer is comprised in an item which is movable (onto and off an optical path to a viewing area) manually and selectively. FIG. 14 illustrates a quite different arrangement in which the movement is essentially random. Referring then to FIG. 14 a large plurality of fore polarizers indicated at 930 is suspended in the form of a mobile subject to essentially random air currents. To each side, behind and above the fore polarizers 930 are screens 932 each backed by an LCD panel and a backlight configured and arranged as described above with reference to FIG. 1. The fore polarizers 930 demultiplex the mutiplexed white light delivered by the screens 932 and thereby produce a plurality of images—shown symbolically in FIG. 14—that change constantly as the fore polarizers move in the air currents.

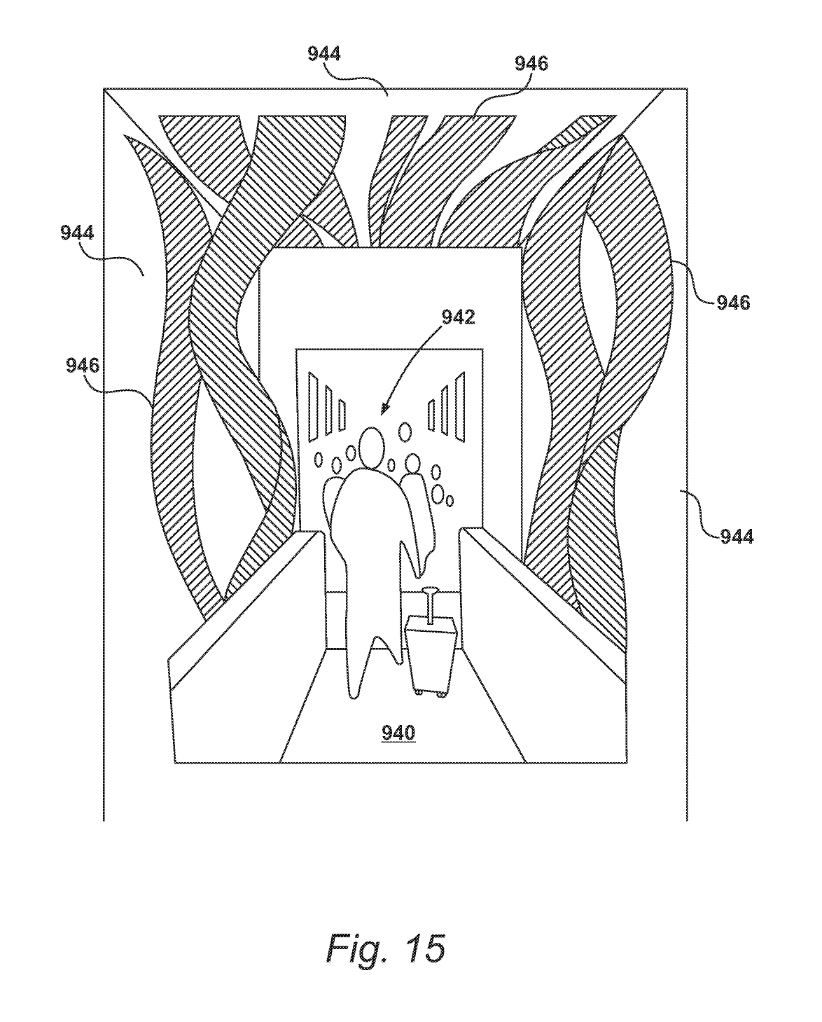

### FIG. 15

Another embodiment of the invention which produces a display that changes constantly and essentially randomly is shown in FIG. 15. In this embodiment a walkway 940 for persons indicated at 942 extends through a viewing area between screens 944 each backed by an LCD panel and a backlight configured and arranged as described above with reference to FIG. 1. To each side of and above the walkway 940 are fore polarizers in the form of ribbons 946. Persons 942 on the walkway see visual images—shown symbolically in FIG. 15—through the ribbons 946, against a white background provided by the screens 944. The ribbons 946 are loosely hung and thus the images viewed by the persons 942 change constantly and essentially randomly as air currents cause the ribbons 946 to move.

The twisted and moving ribbons of FIG. 15 produce abstract and/or interestingly distorted images comprising engaging art works that are different with every viewing. This arrangement is especially suited to the production of impactful visual displays, for instance in clubs or in hotel, restaurant or catering establishments.

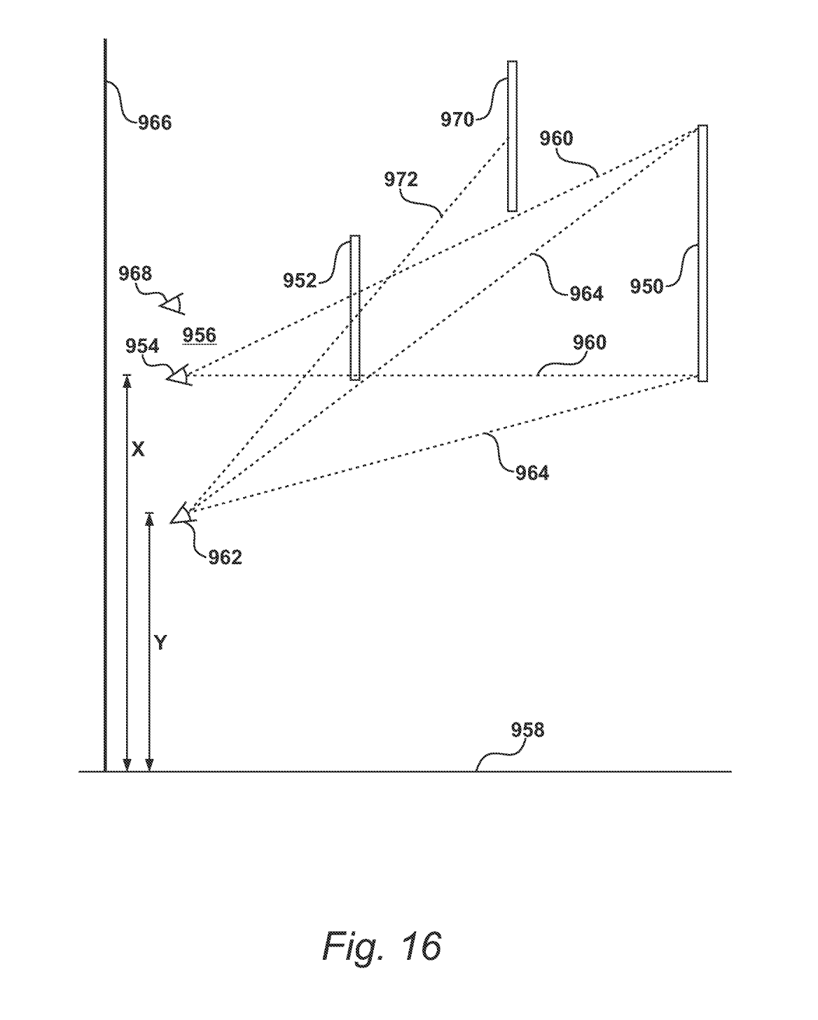

Those skilled in the art will appreciate that the present invention may well be used for the advertising and promotion of products and services inappropriate for young persons. For instance, the embodiments of FIGS. 2, 3, 4 and 9 may be used in relation to cigarettes or other tobacco products that in many jurisdictions must not be sold to persons under a specified age; similarly there are widespread minimum age restrictions and the sale and consumption of alcoholic beverages, in connection with which the embodiment of FIG. 12 may be used; and of course the embodiment of FIG. 13 may be used to exclude under-age persons from premises such as adult clubs. An embodiment of the invention explicitly configured with children in mind is illustrated by FIG. 16.

### FIG. 16

Referring then to FIG. 16 this shows an arrangement having an LCD screen 950. A fore polarizer 952 fixed in front of the screen 950 enables a visual image to be seen from a viewpoint 954 in a viewing area 956, through the fore polarizer 952. If the visual image relates to cigarette smoking, say, it is desirable and may be legally necessary for it to be concealed from minors. In the arrangement of FIG. 16 this is effected as follows. The screen 950 and polarizer 952 are relatively so disposed that an adult person in the viewing area 956 whose viewpoint 954 is around an average height x from a floor 958 for viewers can look through the polarizer 952 to see the visual image. The field of view from the viewpoint 954, by way of the polarizer 952, is indicated in broken lines at 960, and can be seen to encompass all of the screen 950. However, from a lower viewpoint 962 at a height y from the floor 958, the screen 950 cannot be seen by way of the polarizer 952, as indicated by the field of view 964. Thus the visual image formed by the interaction of the polarizer 952 with the screen 950 cannot be seen from the lower viewpoint 962, but only the blank screen 950. Since children are (almost without exception) shorter than adults, the effect of the arrangement of FIG. 16 is that children cannot see the visual image that adults can see. And a wall or similar barrier 966 prevents children from backing away from the screen 950 in an attempt to see the screen 950 through the polarizer 952.

Those skilled in the art will appreciate that the screen 950 and the polarizer 952 are so disposed so that the visual image can be seen from viewpoints such as 968 somewhat higher than x. If the screen 950 and the polarizer 952 are so disposed as to allow the visual image to be seen from viewpoints in the range 1.5 m to 1.9 m high, this will accommodate a very large proportion of adult people; whilst if y □ 1.5 m, the visual image will be invisible to most elementary school children, a height of 1.5 m being above their eye level on average. In other words, the viewing area 956 for the adults-only visual image extends upwards of a specified height (say 1.5 m) from the floor 958, but not below this height.

It will be understood that an alternative screen 970 may be provided, if desired, to enable an alternative image, suitable for children, to be seen at or below the lower viewpoint 962, as indicated by the optical path 972 extending through the polarizer 952 to the alternative screen 970.

It will also be understood that, other than an alternative screen 970, the invention may be configured so that a child-oriented image can be seen from viewpoints below some specified height, eg 1.5 m, but not above that height. In this way children can see things (a “hidden world”) not normally seen by adults because their eye level is too high.

As described herein, the invention uses an LCD panel of the twisted nematic type. This is a convenient way of implementing the invention. However it will be understood by those skilled in the art that other kinds of LCD technology may be used in the invention, such as in-plane switching, super in-plane switching or (advanced) fringe field switching. Further, other technologies may possibly be used, for instance organic light-emitting diodes (OLED), provided that any such technology provides multiplexed RGB light to produce a white display and separately demultiplexes it to reveal a visual image.

What we claim is:

1. Visual display apparatus comprising:
a screen viewable from a viewing area and including an array of pixels;
a lighting device operative to illuminate the pixels thereby to produce illumination directed along a path towards the viewing area;
a control device operative selectively on the pixels to modulate said illumination in relation to a visual image; and
a filter device operative to filter the modulated illumination thereby to reveal the visual image;
wherein the screen and the filter device are relatively so configured and arranged that in the viewing area the visual image and the modulated illumination are alternatively displayed.

2. Visual display apparatus as claimed in claim 1 wherein each said pixel comprises a set of RGB sub-pixels, whereby the visual image is colored.

3. Visual display apparatus as claimed in claim 1 wherein the screen is included in an LCD panel and the filter device comprises a first polarizer and a second polarizer, which polarizers are mutually crossed.

4. Visual display apparatus as claimed in claim 3 wherein the first polarizer is located between the lighting device and the LCD panel and the second polarizer is located between the LCD panel and the viewing area.

5. Visual display apparatus as claimed in claim 4 wherein the second polariser is fixed relative to the first polarizer.

6. Visual display apparatus as claimed in claim 5 wherein the second polariser has the form of an emblem.

7. Visual display apparatus as claimed in claim 6 wherein said emblem comprises a trade mark for a product or service to which the visual image relates.

8. Visual display apparatus as claimed in claim 7 wherein the second polarizer is free standing.

9. Visual display apparatus as claimed in claim 7 wherein the second polarizer is mounted on a window.

10. Visual display apparatus as claimed in claim 5 wherein the second polarizer is contained within a transparent block for display at commercial premises.

11. Visual display apparatus as claimed in claim 5 wherein the second polarizer comprises a plurality of strips extending across and above a table containing the LCD panel.

12. Visual display apparatus as claimed in claim 5 wherein the second polarizer is located on a transparent raised portion of a stand for products.

13. Visual display apparatus as claimed in claim 5 wherein the second polarizer is embodied in a wall.

14. Visual display apparatus as claimed in claim 13 wherein the second polarizer comprises a plurality of bands that are intercalated with non-polarizing areas.

15. Visual display apparatus as claimed in claim 4 wherein a movable one of said first and second polarizers is movable between an operative position on said path whereby the visual image is displayed in the viewing area and a null position off said path whereby the white light is displayed in the viewing area.

16. Visual display apparatus as claimed in claim 15 wherein the movable polarizer is movable selectively and manually.

17. Visual display apparatus as claimed in claim 16 wherein the movable polarizer is carried on a transparent block.

18. Visual display apparatus as claimed in claim 17 wherein said system is embodied in a promotional package containing a product to be promoted and said block has a shape matching that of said product.

19. Visual display apparatus as claimed in claim 18 wherein the promotional package is configured and arranged to locate the movable polarizer in its operative position properly crossed with the other polarizer.

20. Visual display apparatus as claimed in claim 15 wherein the movable polarizer has dimensions transversely of said path that are substantially the same as those of the LCD panel, whereby in its operative position the movable polarizer is transversely coterminous with the LCD panel.

21. Visual display apparatus as claimed in claim 20 wherein the movable polarizer has dimensions transversely of said path that are smaller than those of the LCD panel, whereby the movable polarizer can be moved around or across the LCD panel.

22. Visual display apparatus as claimed in claim 21 wherein the movable polarizer is embodied in a manually portable item and the LCD panel is contained in a support for said item.

23. Visual display apparatus as claimed in claim 22 wherein said manually portable item includes NFC means for communicating sound relating to the visual image.

24. Visual display apparatus as claimed in claim 22 wherein said manually portable item comprises a container for drinks.

25. Visual display apparatus as claimed in claim 22 wherein said visual image comprises a code giving access to a restricted area.

26. Visual display apparatus as claimed in claim 4 wherein the movable polarizer is movable automatically.

27. Visual display apparatus as claimed in claim 26 wherein the second polarizer is movable by air currents.

28. Visual display apparatus as claimed in claim 27 wherein the second polarizer comprises a plurality of elements suspended to form a mobile.

29. Visual display apparatus as claimed in claim 27 wherein the second polarizer comprises a plurality of ribbons.

30. Visual display apparatus as claimed in claim 1 wherein the screen and the filter device are so disposed that the viewing area extends above but not below a specified height above a floor for viewers.

31. Visual display apparatus as claimed in claim 30 wherein said specified height is below the average eye level of elementary school children.

32. Visual display apparatus as claimed in claim 31 wherein the viewing area is bounded by a wall or the like.

33. Visual display apparatus as claimed in claim 1 wherein the screen and the filter device are so disposed that the viewing area extends above but not below a specified height above a floor for viewers.

34. A method of producing a visual display in a viewing area, which method comprises providing a screen viewable from the viewing area and including an array of pixels, illuminating the pixels to produce illumination directed along a path towards the viewing area, optically modulating the illumination in relation to a visual image and optically filtering the modulated illumination to reveal the visual image, wherein the modulation of the illumination and the filtering of the illumination are mutually separated so that the modulated illumination and the visual image are alternatively displayed in the viewing area.

35. A method of producing a visual display as claimed in claim 34 wherein the modulated illumination is filtered by two mutually crossed polarizers.

36. A method of producing a visual display as claimed in claim 35 wherein the two polarizers are mutually spaced apart to display the modulated illumination as well as the visual image simultaneously in the viewing area.

37. A method of producing a visual display as claimed in claim 35 wherein one said polarizer is moved relative to the other said polarizer between an operative position wherein the visual image is displayed in the viewing area and a null position wherein the modulated illumination is displayed in the viewing area.
